(19) United States
(12) Patent Application Publication
(10) Pub. No.: US 2004/0107954 A1
(43) Pub. Date: Jun. 10, 2004

(54) Disposable barbeque oven liner

(76) Inventors: William Biluk, Sault Ste. Marie (CA); Susan M. Nicol, Sault Ste. Marie (CA); Bryan W. Biluk, Sault Ste. Marie (CA)

Correspondence Address: GREER, BURNS & CRAIN, 300 S WACKER DR, 25TH FLOOR, CHICAGO, IL, 60606, US

(21) Appl. No.: 10/313,546

(22) Filed: Dec. 6, 2002

(51) Int. Cl. A47J 37/00

(52) U.S. Cl. 126/25 R

(57) ABSTRACT

A disposable, easy-to-install, flexible, fire-resistant, multi-sectional oven liner is adapted to be conformed to the inner surfaces of a barbeque grill in order to improve the cooking properties and to contain splatter from food products cooking therein.

### FIELD OF INVENTION

This invention relates to flexible disposable barbeque shields, and more particularly, to liners adaptedly positionable on the sides of the barbeque to protect the interior of said barbeque from dirt, drippings, grease and smoke.

### BACKGROUND OF INVENTION

The use of disposable metal foils to protect a barbeque is known in the prior art. Even though these innovations may have been suitable for the specific purposes to which they refer, they differ from the present invention as hereinafter disclosed.

For example, U.S. Pat. No. 4,969,449 discloses a disposable grill cover corrugated with holes which sits so that the troughs of the corrugation align with the spacings of the wire grill.

U.S. Pat. No. 5,586,491 discloses a disposable flexible foil product to be placed on a barbeque grill comprising a sheet of metal foil with rectangular vents, said foil product being dispensable either from a roll or packaged in flat sheets or pans.

U.S. Pat. No. 6,101,931 discloses a disposable, flame-resistant grill liner having one or more pleated sections to enable the grill liner to be conformed to the interior surfaces of the grill.

Although the grill liners described above are designed to be placed inside the barbeque, they are adapted to protect mostly the wire rack cooking surface from dirt and grease, or only partially the sides of the barbeque. As a result, there is a need for a barbeque oven liner which can be used in a wide variety of barbeque grills and which protects the side grill surfaces from dirt, drippings, grease, soot and other undesirable materials from adhering to the interior side surfaces of the grill. It is well established that the quality of the barbequed meat may suffer due to the burning of residues remaining in the barbeque from previous use.

Therefore, it can be appreciated that there is a need for a disposable barbeque liner which is positioned on the sides of the grill, is non-labour intensive to use, is adjustable to any size grill and is easy and inexpensive to manufacture and package.

### SUMMARY OF THE INVENTION

It is an object of the present invention to overcome the above shortcomings.

The present invention pertains to a grill oven liner designed to reduce clean-up of a grill after food has been prepared, and more particularly to a disposable grill oven liner to be positioned on the sides of the grill in order to prevent dirt, drippings, grease, soot and other similar by-products from adhering, staining and caking the interior sides of the grill when the food is prepared.

One aspect of the present invention resides in the use of flexible, fire-resistant material which can easily be conformed to the interior sides of a grill and which is adjustable to any size grill, and is easy and inexpensive to manufacture and package. The flexible material is preferably a metal material such as aluminum, however, other types of metals may be used.

It is another object of the present invention to provide a grill oven liner which is simple and easy to use and clean.

Another object of the present invention is to provide a grill oven liner which is of a durable and reliable construction and results in more efficient energy use.

Yet another object of the present invention is to provide a grill oven liner which is recyclable.

Still yet another object of the present invention is to provide a disposable barbeque grill oven liner for covering inner side surfaces of a grill comprising four flexible metal panels having a top portion and a base portion, said top portion including an adjustable pleat enabling secure positioning of said flexible metal panels onto said side surfaces wherein said panels conform to said side surfaces to protect the grill side surfaces from splatter.

### BRIEF DESCRIPTION OF THE DRAWINGS

FIG. 1 is a partially cut away exploded perspective view of a conventional gas barbeque grill illustrating one of the four panels of the liner to be deployed of the present invention; and

FIGS. 2a, 2b, 2c and 2d are front views of the disposable panels of the present invention.

### DETAILED DESCRIPTION OF THE PREFERRED EMBODIMENTS

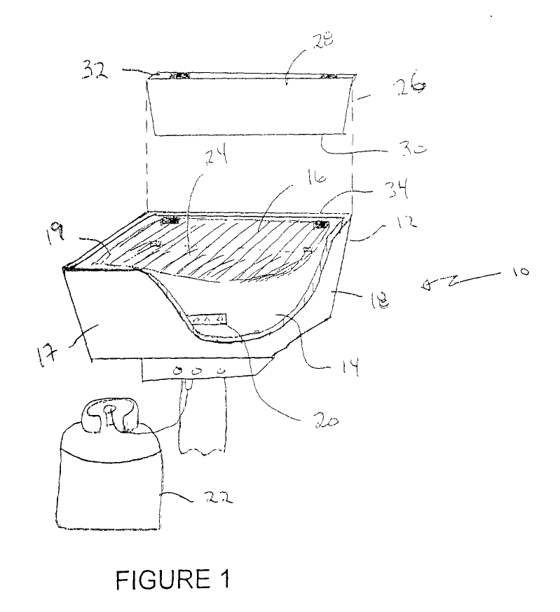

Referring first to FIG. 1, a conventional gas barbeque grill 10 is illustrated which has a housing 12, or oven, with a bottom section 14, side walls 16 and 17 and end walls 18 and 19, or generally side surfaces. A gas burner unit 20 is provided above bottom section 14 and is supplied with gas from tank 22. A food supporting grate 24 is supported horizontally in the upper portion of housing 12 for placing the food products to be grilled.

As shown in FIG. 1, the disposable barbeque oven multi-sectional liner of the present invention is comprised of four individual panels, one of which is illustrated as 26, to be securely positioned within housing 12 of the grill 10, having a top portion 28 and a base portion 30, said top portion 28 having an adjustable pleat 32 for enabling secure positioning of said panel 26 onto edge 34 of side surface, or more particularly in the case of panel 26 onto side wall 16, wherein said panel 26 conform to said side wall 16 in order to protect the grill side wall 16 from splatter such as dirt, drippings, grease, soot or other undesirable materials from adhering to the interior side surfaces of the grill 10.

Generally, it is understood that to cover the entirety of the grill 10 housing 12 interior, or oven section, four individual panels, which can be made of flexible, pliable, fire-resistant material such that it can easily be conformed to the side surfaces, that will also be resistant to degradation during use, will be adapted to conform horizontally and vertically to both side walls 16 and 17 and to both end walls 18 and 19 i.e. all interior side surfaces of the grill 10. It is also understood that the panels could be moulded into a single unit although a single unit would be more difficult to easily conform to different size side surfaces and would also require more storage and package space.

Preferably, the panels are made out of an environmentally friendly, recyclable metal material, such as aluminum which is also selected for being durable when used, yet pliable and easily adjustable, or cut to size, to fit different size grills in order to conform to the interior surfaces of the grill. Furthermore, it makes for an easy and inexpensive product to manufacture and package. Also, it has been shown that better cooking performance will result from having the panels in place hence more efficient energy use.

Pleat 32 formed at the top portion 28 in panel 26 can be formed by any standard pleating process and can easily be adjusted to fit different size edge 34 in light of the pliability of the material used in making the panel 26.

The liner panels are also designed to be easily cleaned when use of the grill 10 is over thus leaving a clean grill 10 for the next cooking session and thereby avoiding the burning of residues from affecting the quality of the barbequed meat.

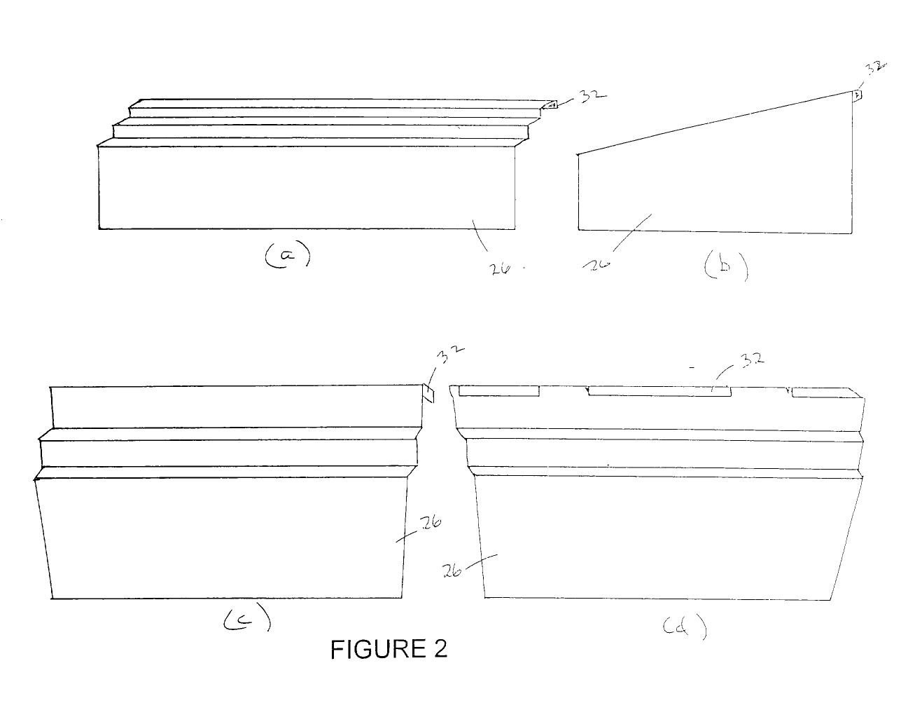

Referring to FIGS. 2a-2d, the individual panels 26 of the present invention are illustrated. FIG. 2a shows a front side panel with ridges adapted to conform the inside of the grill 10 and the grate 24 to be positioned therein. FIG. 2b shows one of two symmetrically identical end wall panels adapted to conform the inside of the grill 10. FIGS. 2c and 2d show a rear side panel with ridges adapted to conform the inside of the grill 10 and the grate 24 to be positioned therein with the back side of said rear side panel (2d) showing cut outs for accommodating the grill 10 cover hinges. Furthermore, the pleat 32 is positioned at the top portion of the panels for secured positioning onto the grill 10 edge 34.

The invention is not limited to the embodiments hereinbefore described, but may be varied within the scope of the claims in construction and detail.

We claim:

1. A disposable barbeque grill oven liner for covering inner side surfaces of said grill comprising four flexible metal panels having a top portion and a base portion, said top portion including an adjustable pleat enabling secure positioning of said flexible metal panels onto said side surfaces wherein said panels conform to said side surfaces to protect the grill side surfaces from splatter.

2. A disposable barbeque grill oven liner according to claim 1, wherein said metal is aluminum.

3. A disposable barbeque grill oven liner according to claim 1, wherein said metal panels are adjustable to fit different size side surfaces.

4. A disposable barbeque grill oven liner according to claim 1, wherein said four flexible panels form a single unit.
